(19) United States
(12) Patent Application Publication
(10) Pub. No.: US 2006/0140442 A1
(43) Pub. Date: Jun. 29, 2006

(54) Steganographic method

(76) Inventors: Asham ElRayess, Kanata (CA); Omar Alobidat, Kanata (CA)

Correspondence Address: GEORGE A. SEABY;SEABY & ASSOCIATES, 250 CITY CENTRE AVNUE, OTTAWA, ON, K1R6K7, CA

(21) Appl. No.: 11/315,339

(22) Filed: Dec. 23, 2005

Related U.S. Application Data
(60) Provisional application No. 60/639,777, filed on Dec. 29, 2004.

(51) Int. Cl. G06K 9/00

(52) U.S. Cl. 382/100

(57) ABSTRACT

A steganographic method for embedding a message in a printed digital image includes the steps of separating the color plane having a color closest to the background color of a target print sheet from the remainder of the image, constructing storage blocks including parallel lines or rectangles within the color plane, each block storing a message fragment, storing components of a message fragment in the blocks, the orientation of the lines or the intensity of the color of the rectangles signifying the value of the components, using some of the components to signify the order of the message fragment in the messages, and using the color plane thus modified to print the image.

### CROSS REFERENCE TO RELATED APPLICATION

This application claims priority on U.S. Provisional Application 60/639,777 filed Dec. 29, 2004.

### BACKGROUND OF THE INVENTION

1. Field of the Invention

This invention relates to a steganographic method, and in particular to a method of embedding messages in printed digital images.

2. Discussion of the Prior Art

It is only in the last ten to fifteen years that information hiding techniques have received much attention by the research community. However, as the need to protect, inter alia, copyright when audio and visual works became available in digital form, interest in information hiding has increased substantially. Consequently, recent steganographic techniques have focused on hiding information in digital media.

### GENERAL DESCRIPTION OF THE INVENTION

An object of the present invention is to provide a relatively simple method of embedding information messages in printed, colored images.

Another object of the invention is to provide a method of reading messages stored in color plated coded images.

According to one aspect, the invention relates to a steganographic method for embedding a message in a printed digital image, comprising the steps of:

(a) identifying a color plane among available color planes in a process color system closest to the background color of a target print sheet;

(b) separating a color plane corresponding to the color identified in step (a) from the rest of the image;

(c) constructing a collection of storage blocks including parallel lines within the separated color plane where each storage block is intended to store a message fragment;

(d) storing components of a message fragment in the storage blocks where the orientation of the lines signifies the value of the component;

(e) using some of the components stored in the storage block to signify the order of the message fragment within the overall message;

(f) substituting the color plane identified in step (a) with the color plane blocks containing the storage blocks; and

(g) printing the image.

In accordance with another aspect, the invention relates to a steganographic method for embedding a message in a printed digital image, comprising the steps of:

(a) identifying a color plane among available color planes in a process color system closest to the background color of a target print sheet;

(b) separating a color plane corresponding to the color identified in step (a) from the rest of the image;

(c) constructing storage blocks including at least two contiguous filled areas within the separated color plane where each storage block is intended to store a message fragment;

(d) storing components of a message fragment in the storage blocks where the variation in the intensity of the color composition of the areas relative to each other signifies the value of the component;

(e) substituting the color plane identified in step (a) with the color plane containing the storage blocks; and

(f) printing the image.

In accordance with yet another aspect, the invention relates to a method of reading a message stored in a color plate coded image comprising the steps of:

(a) acquiring the image using a digital image reading device;

(b) performing color separation of the acquired image;

(c) isolating a code plane from the image;

(d) identifying individual blocks on the code plane;

(e) interpreting each code block to retrieve a message fragment; and

(f) assembling the message fragments to identify a full message.

### BRIEF DESCRIPTION OF THE DRAWINGS

The invention is described below in greater detail with reference to the accompanying drawings wherein:

FIG. 1 is a schematic diagram illustrating the process of color separation;

FIG. 2 is a schematic, exploded view of a code plane;

FIG. 3 is a top view of a storage block;

FIG. 4 is a top view of an alternative form of storage block; and

FIG. 5 is a schematic, exploded view of a storage block on a code plane.

### DESCRIPTION OF THE PREFERRED EMBODIMENT

Color plate encoding is used in conjunction with process color printing, information being hidden in one color plane of the printed image.

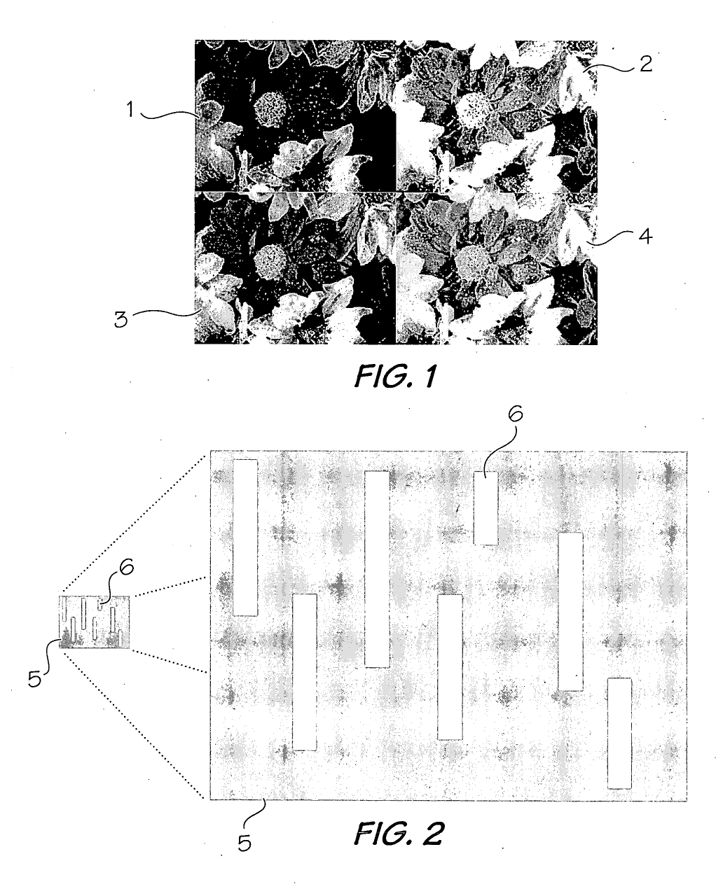

Process color printing is a procedure of separating an image into multiple single-color planes before sending it to the printer. The color pigments supported by the target printer determine the color planes. CMYK printing is an industry standard method of printing in full color, where CMYK stands for the four colors: cyan, magenta, yellow, and key (black) used as part of this standard. In desktop publishing using inkjet printers, an image is run through specific software that performs color separation, resulting in four separate color planes. The planes are then sent to the printer, which runs the corresponding ink through each of the planes to produce the printed image. FIG. 1 illustrates the process of color separation. In FIG. 1, the original image 1 at the top left is separated into cyan 2 shown schematically at the top right, magenta 3 at the bottom left and yellow 4 at the bottom right.

In color plate encoding, information is hidden in a code plane, which is the color plane 2, 3 or 4 closest in color to the print sheet. For example, when printing on a white sheet, using the CMYK process color, the code plane is the yellow plane, because yellow is the brightest color after white. The steps involved in color plate encoding include:

(1) identifying a code plane to be used for message storage and retrieval, i.e. the code plane;

(2) performing color separation on the original image, and sending all color planes, except the code plane, to the printer;

(3) creating storage blocks, each of which contains a fragment of the stored message (message fragment);

(4) imprinting the storage blocks onto the code plane - each storage block being imprinted a number of times at different locations in the code plane for the sake of redundancy; and

(5) sending the code plane to the printer. Alternatively, all of the color planes referred to in step 2 can be sent to the printer after step 5.

The choice of color plane in which the message will be stored depends upon the target printer and the color of the print sheets. Generally, the code plane color is the color from the printer color set that is closest in visual perception to the color of the print sheet.

The overwhelming majority of currently available printers utilize a CMYK process color printing. As mentioned above, when printing on white sheets, the choice of color for the code plane is yellow,. for the obvious reason that yellow is the second brightest color after white. For the unaided eye, it is typically difficult to perceive minute discontinuities in a thin yellow line printed on a white sheet. Just as in FIG. 2, the light gray area 5 which represent yellow is hard to distinguish from the underlying white sheet 6.

With respect to storage block creation, a message that will be stored in color plate coded image is divided into message fragments. Each message fragment is stored in a storage block. Storage blocks are ordered and imprinted onto the code plane with redundancy. A message that will be stored in a color plate coded image, whether textual or numeric must first be converted into a digital equivalent. Color plate encoding stores the message on the image in a binary, trinary, or n-ary format.

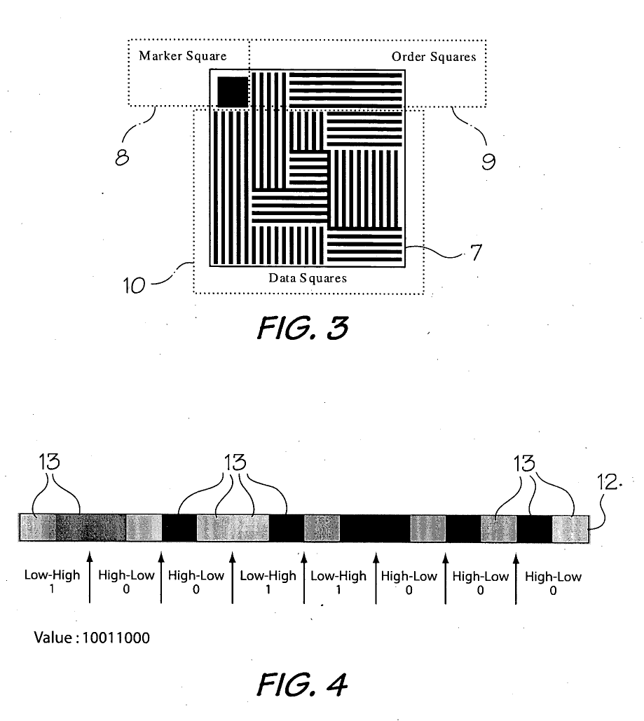

Once the message is converted, it is divided into message fragments, each stored in one storage block 7 (FIG. 3). The number of message fragments is determined by the length of the message and the length of data that can be held in a storage block 7. For example, if the message is 320 digits long, and each storage block 7 can hold 20 digits, the total number of message fragments is 16.

A storage block 7 is a graphic construct, which, as shown in FIG. 3, is typically a square or a rectangle that consists of a collection of squares. With the exception of a marker square 8 (explained below), each square represents a single digital value. A square is filled entirely with unidirectional parallel lines. The frequency of the lines depends on the following factors.

the frequency of the lines must be high enough so that, to the unaided eye, each square appears as a solid graphical entity.

the frequency of the lines must be low enough so that the target image capture device (at its set resolution) is capable of capturing the orientation of the lines.

Two orientations (horizontal or vertical) may be used in conjunction with a binary storage system (representing 0 or 1), while three orientations (horizontal, vertical, or diagonal) may be used in trinary storage system (representing 0, 1, or 2). While the trinary system is able to store more data within the same area, it requires higher printing and scanning resolutions than the binary system in order to correctly identify the stored value. An n-ary system may be used if the resolution and performance of the image capturing devices makes it possible to capture the angular orientation of the lines without significant distortion.

Squares in a storage block 7 are divided into three categories based on their function: marker 8, order 9 and data 10.

The color plate encoding reading program uses a marker square 8 to identify individual blocks. There is one and only one marker square 8 per storage block. The contents of the marker square 8 must be distinguishable from the other squares 9 and 10 in order to enable the reading program to identify the boundaries of individual blocks. For example, as shown in FIG. 3, the contents of the marker square 8 can be solid (although different methods of identifying marker squares may be used, e.g. diagonal orientation of lines in marker areas for binary storage systems).

The order squares 9 determine the position of the message fragment stored in the storage block 7 within the message. The number of order squares 9 must be sufficient to identify the total number of message fragments. For example, if a binary storage system is used, and the total number of message fragments is 16, then 4 squares must be reserved for ordering (where the binary value of “0000” represent the decimal value of “0”, and the binary value of “1111” represent the decimal value of “15”, for a total of 16 distinct values). The data squares 10 are where the partial message data is stored.

FIG. 3 shows a storage block 7, where the block order is “1000” (decimal 8), and the stored data is “11100110111001111100” (decimal 945788). Note that the total number of squares in a storage block 7 is determined by the application requirements but must achieve a balance between the need for redundancy, as expressed by repeating message fragments in different locations on the image, and the area limitations of the printed image.

As illustrated in FIG. 4, an alternative manner of representing the components of a message fragment in a storage block 12 is by making the fragment correspond to at least two filled areas, in this case rectangles 13 where the variation in intensity of the color composition of the rectangles relative to each other signifies the value of the component of the message fragment (e.g. “0” or “1” in the case of a binary storage system). The intensity of the color composition of the rectangles is based on the intensity of the code plane in the original image, but is shifted to create sufficient differentiation between adjacent rectangles. In the 8-component storage system of FIG. 4, each component consists of two rectangles (the arrows point to the ends of the components). The differences in color denote binary storage values, i.e. low to high intensity means “1” and high to low intensity means “0”.

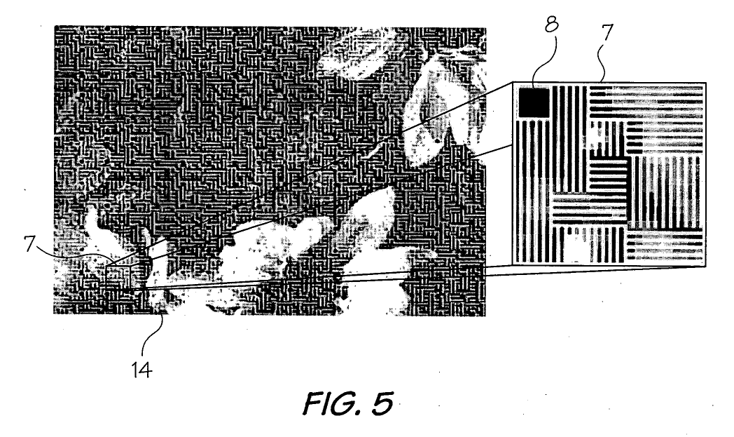

Referring to FIG. 5, when using storage blocks 7 of the type illustrated in FIG. 3, after constructing the storage blocks 7 they are imprinted onto a code plane 14. The imprinting process rebuilds the original code plane using the storage blocks 7. To achieve this, the code plane 14 is divided into areas; the size of each is equivalent to the size of a storage block, with the exception of the edge areas that may not accommodate a full block.

As illustrated schematically in FIG. 5, a storage block 7 is imprinted onto its area by modifying the intensity (value) of each pixel in the storage block according to the intensity of the corresponding pixel in the area. Varying the intensity of the lines according to the intensity of the image color minimizes distortion of the image. Once this process is complete, the area is replaced with the modified storage block.

Depending on the image used, the imprinting process may render some of the storage blocks 7 unreadable in some areas, especially when the intensity of the code plane 14 at these areas is low (e.g. white areas in image when printing on a white sheet). Also, the final image may contain other information printed on top of it, such as textual information printed on top of a background image in identification cards. For this purpose, the arranging of storage blocks 7 onto areas is not random but uses a special allotment algorithm.

The allotment algorithm for assigning storage blocks 7 onto areas analyzes the image prior to imprinting the blocks. Each area is assigned a weight according to the intensity of the code plane 14 within the area. If other information (e.g. textual) will be printed on top of the image, the allotment algorithm must be aware of its assigned space in order to factor it when calculating the weight. Once the weight is calculated for all areas, the areas are sorted in descending order according to their weight. The storage blocks 7 are assigned to the sorted areas using an algorithm that seeks to ensure that each of the distinct message fragments will be stored on as many highly readable areas as possible. For example, when distributing 4 blocks onto 16 areas (sorted according to their descending weights), the blocks are assigned in the following order (1,2,3,4,4,3,2,1,1,2,3,4,4,3,2,1).

“Redundancy factor” is defined as the required number of repetitions of each storage block 7 in areas with weights above a specific threshold. Certain applications (such as secure documents) require higher confidence in the message retrieval process and a higher redundancy factor. If the allotment algorithm is unable to achieve the redundancy factor for the application, the image is said to be non-usable for color plate encoding. Under such conditions, a different image may be used or other factors investigated, e.g. the positioning of textual information on the printed image.

Once the code plane 14 is imprinted with the storage blocks 7, it is sent to the printer. Any additional information that is printed on top of the image may also be sent at this stage. The print job is finalized and closed and the printer starts the production process.

The storage blocks 12 of FIG. 4 can be substituted for the storage blocks 7 in the above described steps of imprinting the blocks onto a code plane 14 and sending the code plane to the printer.

In order to read the message, the first step is to use an image capture device, e.g. digital scanner or a digital camera to acquire a digital copy of the image. The image capture device must be capable, at its set resolution, to preserve the orientation quality of the lines or the color composition of the rectangles within the storage blocks 7 or 12.

The reading program performs color separation on the acquired image in a manner similar to that described above. The code plane 14 is passed to the next stage while the other planes may be discarded.

The reading program analyzes the code plane 14 in search of the marker squares 8. Once identified, the marker squares 8 are used to recognize the boundaries of the storage blocks 7. The image is divided according to these boundaries into areas, each containing a single storage block 7. The isolated storage blocks 7 are passed to an interpretation stage.

Storage blocks 7 or 12 are passed individually to an interpreter, i.e. a program for extracting the value stored in the storage blocks. The interpreter divides a block into squares or rectangles based on its pre-knowledge of the block and square dimensions and composition.

The interpreter analyzes each square individually to determine the orientation of the lines within the square (or, if the alternative method of representing blocks is used, the color composition of adjacent rectangles). This can be done simply by comparing the horizontal variation in pixel intensity value against the vertical variation (in case of binary storage system). In situations where the difference between the horizontal and vertical variations falls within an application specific threshold (orientation threshold), the read value of the square is said to be undetermined.

The interpreter starts by attempting to extract the order of the storage block 7, i.e. the order of the message fragment stored in the block. If the order of the storage block 7 is correctly extracted (no undetermined squares encountered), the interpreter proceeds to extract the values stored in the data squares 10.

For each storage block 7 (identified by its order), the interpreter keeps track of the value determined for the individual squares. If the orientation threshold is set to a low value, it is possible that discrepancies in data reading may occur. The interpreter handles such occurrences in an application-specific manner. A “majority rule” approach may be used with certain applications, where a square marked as having the value “0” seven times and marked as having the value “1” a single time, for the same block, is considered to have the value “0”. For applications with stricter requirements, the same occurrence may yield the read square value to be undetermined.

At the end of this stage, all message fragments of the stored message should have been extracted. For a binary system storing a total of 40 digits spread across 4 blocks, the output of this stage may look like the following:

Value stored in Block 1: 1001010100

Value stored in Block 2: 0100101001

Value stored in Block 3: 0111100101

Value stored in Block 4: 1001011*00

Note that the * in Block 4 denotes an “undetermined” value. Although multiple safeguards are in place to avoid such occurrences, it is possible to encounter them in real life, e.g. worn out images.

Each block is converted individually to the original message format such as textual or decimal. For example, the above blocks are translated, in the case of simple decimal conversion, to the following values:

Value stored in Block 1: 596

Value stored in Block 2: 297

Value stored in Block 3: 485

Value stored in Block 4: 600 or 604

The individual blocks are then assembled to form the message. In the case where undetermined values have been encountered (as in the example above), the output of the assembly process is a set of messages, along with their associated probabilities. In the above example, the output from the assembly process is {(596297485600, 50%), (596297485604, 50%)} indicating that each of the specified values has a 50% probability. Interpreting the message and handling discrepancies is in the parent application domain.

In practical tests, it was possible using this method to store and reliably read a 96 digit decimal value in an image occupying a credit-card size (3×2 inches) area, with textual information printed on top, using a low-range inkjet printer (300 dpi) and a common off-the-shelf scanner (300 dpi scan resolution). The interpreter successfully identified an average of 5 occurrences for each block (where each block was repeated 8 times on the code plane), with 3 being the minimum number of identifications for a single block.

As well as copyright protection mentioned above, there are many potential practical applications for the color plate encoding method described hereinbefore. Examples of such applications include storing product identification information, such as the serial number of a product, on the packaging, allowing for machine reading of the information; and storing personal information, such as the name and the date of birth of a person on documents, e.g. credit cards and driver's licenses allowing for machine reading of the information.

1. A steganographic method for embedding a message in a printed digital image, comprising the steps of:
(a) identifying a color plane among available color planes in a process color system closest to the background color of a target print sheet;
(b) separating a color plane corresponding to the color identified in step (a) from the rest of the image;
(c) constructing a collection of storage blocks including parallel lines within the separated color plane where each storage block is intended to store a message fragment;
(d) storing components of a message fragment in the storage blocks where the orientation of the lines signifies the value of the component;
(e) using some of the components stored in the storage block to signify the order of the message fragment within the overall message;
(f) substituting the color plane identified in step (a) with the color plane containing the storage blocks; and
(g) printing the image.

2. The method of claim 1, wherein the intensity of the lines in the storage blocks is varied, based on the color of the original image, to minimize distortion of the image.

3. The method of claim 1 wherein each storage block is square.

4. The method of claim 1 including the step of incorporating a marker in a block to indicate the location of the storage block.

5. The method of claim 1, wherein storage blocks corresponding to individual message fragments are repeated within an image to add redundancy.

6. The method of claim 1, wherein storage blocks corresponding to individual message fragments are repeated and assigned to areas on the image with each distinct message fragment stored on as many highly readable areas as possible.

7. A steganographic method for embedding a message in a printed digital image, comprising the steps of:
(a) identifying a color plane among available color planes in a process color system closest to the background color of a target print sheet;
(b) separating a color plane corresponding to the color identified in step (a) from the rest of the image;
(c) constructing storage blocks including at least two contiguous filled areas within the separated color plane where each storage block is intended to store a message fragment;
(d) storing components of a message fragment in the storage blocks where the variation in the intensity of the color composition of the areas relative to each other signifies the value of the component;
(e) substituting the color plane identified in step (a) with the color plane containing the storage blocks; and
(f) printing the image.

8. The method of claim 7, wherein the intensity of color composition of the areas in the storage blocks is varied, based on the color of the original image, to minimize distortion of the image.

9. The method of claim 7 wherein each filled area is rectangular.

10. The method of claim 7, wherein storage blocks corresponding to individual message fragments are repeated within an image to add redundancy.

11. The method of claim 7, wherein storage blocks corresponding to individual message fragments are repeated and assigned to areas on the image with each distinct message fragment stored on as many highly readable areas as possible.

12. A method of reading a message stored in a color plate coded image comprising the steps of:
(a) acquiring the image using a digital image reading device;
(b) performing color separation of the acquired image;
(c) isolating a code plane from the image;
(d) identifying individual blocks on the code plane;
(e) interpreting each code block to retrieve a message fragment; and
(f) assembling the message fragments to identify a full message.
